(19) United States
(12) Patent Application Publication
(10) Pub. No.: US 2025/0347885 A1
(43) Pub. Date: Nov. 13, 2025

(54) ACCESSORY FOR PROTECTING SPLICED OPTICAL FIBRES, OPTICAL FIBRE CABLE ASSEMBLIES, KITS OF PARTS, METHODS OF MANUFACTURE AND INSTALLATION THEREOF

(71) Applicant: EMTELLE UK LIMITED, Hawick (GB)

(72) Inventors: Anthony RODGERS, Saltcoats (GB); Eben Colin KIRKPATRICK, Hawick (GB); Jean-Pierre TERBLANCHE, Hawick (GB); Morten JENSEN, Sonder Felding (DK)

(73) Assignee: EMTELLE UK LIMITED, Hawick (GB)

(21) Appl. No.: 18/861,033

(22) PCT Filed: May 11, 2023
(86) PCT No.: PCT/EP2023/062619

§ 371 Date: Oct. 28, 2024

(30) Foreign Application Priority Data
May 26, 2022 (GB) 2207756.4
Nov. 23, 2022 (GB) 2217525.1

(51) Int. Cl. G02B 6/52; G02B 6/255; G02B 6/54

(52) U.S. Cl. CPC G02B 6/52; G02B 6/2558; G02B 6/54

(57) ABSTRACT

A protective body 800 is provided to protect a spliced joint (912) between two optical fibres. The protective body is small, robust and streamlined so that the cable including the spliced joint can be installed in a microduct, for example by blowing. A pre-terminated cable assembly (1000, 1200) comprises a length of cable (1110, 1210) in which one or more optical fibres (306) are embedded in a coated fibre bundle. An extruded sheath (324) covers the coated fibre bundle. A ferrule sub-assembly (1124a, 1224a) is pre-arranged on a leading end of the cable. After passing through a duct, the sub-assembly (1124a, 1224a) becomes part of a pluggable connector (500). For the manufacture of such cable assemblies, a supply (1152) of pre-terminated fibre “tails” is made. These tails are then spliced to the ends of a longer cable, to form the cable complete assembly of desired length.

### FIELD OF THE INVENTION

The present invention relates to optical fibre cables and accessories for protecting spliced joints in optical fibres. The invention further relates to pre-terminated (also called “pre-connectorised”) optical fibre cables and improved methods of manufacture and installation of pre-terminated optical fibre cables. The invention further relates to improved methods of installation of field-terminated optical fibre cables.

### BACKGROUND TO THE INVENTION

Optical fibres can be installed through a duct, for example a so-called micro-duct, using compressed gas or fluid, for example air. This is known as installation by blowing, and special lightweight cable assemblies known as “fibre units” or “microcables” have been developed for this installation method. Optical fibres can also be installed by pushing, or pulling, or preinstalled in a duct. Different cable designs can be used for these different methods.

Fibre to the home (FTTH) is the generic term for broadband network architecture that uses optical fibre technology to carry data to a residential dwelling from a broadband service provider via a telecommunications cabinet located near the residential dwelling. Embodiments of the present invention may be applied in FTTH applications, or in installation of optical fibres to a variety of premises (FTTx) and within premises. The so-called “Internet of Things” (IoT) also requires that smart devices can be connected almost anywhere, and optical fibre forms a key enabler of these networks also.

Several different constructions of fibre units have been designed specifically for installation by blowing. To be successful, such units require to be lightweight, but have a certain stiffness. There is also a significant requirement for fibre units to be compact, for example being around 2 mm or less, often less than 1.5 mm in diameter, when only a few fibres are involved. One type of fibre unit adapted to be installed by the blowing process comprises a number of optical fibres embedded in a solid resin, for example a UV-cured acrylate resin, which locks the fibres in a unitary matrix. This coated fibre bundle is then covered by an outer sheath, for example a sheath or sleeve of low friction, thermoplastic material. The sheath material typically comprises HDPE with a friction-reducing additive. Examples of this type of fibre unit are disclosed for example in WO2004015475A2. Another patent application WO2019053146A1 describes a fibre unit for blowing which is distinguished by a degree of cross-linking being applied in the HDPE sheath. This fibre unit has also been exploited commercially in recent years. A more recent patent application WO2022049057A1 describes a fibre unit having an extruded sheath of PBT or similar material, with a friction-reducing additive. Variants of these coated fibre bundle designs may include strengthening elements, such as fibre reinforced plastic (FRP) elements embedded alongside the fibres in the solid resin. Such variants can be more versatile, for example allowing installation by blowing, pushing and/or pulling, all in one design.

In order to reduce the risk of faulty installations, to speed up the installation and reduce the requirement for specialist skills and equipment, there is a trend to use pre-terminated or “pre-connectorised” cable assemblies. At one or both ends of a pre-terminated cable assembly, one or two ferrule sub-assemblies are generally attached to one or two optical fibres respectively, prior to installing the optical fibres between the consumer site, for example a residential dwelling and a supply site, for example a telecommunication cabinet. An optical ferrule is typically a cylinder of material (for example zirconia, ceramic or plastic), having a small bore into which the glass element of the optical fibre is inserted and cemented, and whose end is then polished to mate with a corresponding ferrule in a mating connector. A mechanical ferrule holder can be provided as part of the ferrule sub-assembly, optionally with a compression spring as well. A blowable ferrule sub-assembly is sized to be small enough to pass through the typical micro-duct, after it has been mounted at the leading end of the fibre unit. It will be understood that such connectors avoid the need to terminate or splice the optical fibre ‘in the field’, that is to say after installation through the duct. prior patent applications WO2018146470A1 discloses one type of pre-terminated cable assembly and its method of manufacture and installation.

Following installation of the pre-terminated fibre unit through a duct, a connector body can be fitted to the ferrule sub-assembly to complete the functional connector. For example, an LC type connector (“local connector”) may be provided at the cabinet end, and an SC type connector (“subscriber connector”) at the premises end. A particular example connector is described in GB2589365A. Of course, other types of connector are available. An unpublished international patent application PCT/EP2022/071493 (with UK priority application 2111589.4) proposes that a restraining part of a ferrule sub-assembly is fixed to a portion of the extruded polymer sheath. The fixing is strong enough to transfer a substantial pull-out force to the body of the pluggable connector, without transferring damaging pull-out forces to the optical fibre within. The present invention in a first aspect aims to further improve the efficiency of manufacturing pre-terminated optical fibre cable assemblies, for example to reduce cost and/or lead time and/or waste.

The present invention in a second aspect aims to provide a protected spliced joint that is small enough and robust enough to be made in an optical fibre cable prior to installation by blowing.

### SUMMARY OF THE INVENTION

A first aspect of the present invention provides a method of assembling a pre-terminated optical fibre cable assembly configured to be installed through a duct, the pre-terminated optical fibre cable assembly comprising:
a first length of cable comprising at least a first optical fibre embedded in a solid resin material to form a first coated fibre bundle and a first extruded polymer sheath covering the first coated fibre bundle;
a shorter, second length of length of cable comprising at least a second optical fibre and having a second extruded polymer sheath;
a ferrule sub-assembly arranged on at least a leading end of the second length of cable, the ferrule sub-assembly being adapted to become, after installation through said duct, part of a pluggable optical connector for making an optical connection to said second optical fibre; and
a spliced joint made between the first optical fibre of the first length of cable and a trailing end of the second length of cable, the spliced joint being encased in a protective body, the protective body surrounding the spliced joint and surrounding portions of said polymer sheath either side of the spliced joint and being of diameter similar to or smaller than the ferrule sub-assembly,
whereby said ferrule sub-assembly, said second length of cable, said spliced joint and protective body together form a leading portion of the cable assembly, adapted for subsequent installation through a duct.

Although the construction of such an assembly appears more complex than the known cable assembly, the inventors have recognised that, provided the protected spliced joint is formed so as to be installable by the desired installation method, such cable assemblies can be manufactured more easily in high volume. This is because the main length of the cable assembly is not present, at the time when the optical ferrule is fitted to the second length of cable. A stock of pre-terminated second lengths of cable can be manufactured much more efficiently, if separated in space and/or time from the manufacture of the cable assembly as a whole.

Depending on the use case, the pre-terminated cable assembly can be made completely or partially in a factory, or it can be made in the field. In either case, benefits can be obtained by pre-terminating a leading end of the cable prior to installation through a duct.

The invention in the first aspect further provides a method of assembling a pre-terminated optical fibre cable assembly configured to be installed through a duct, the method which is performed prior to installation in said duct comprising the steps:
(a) providing a first length of cable comprising at least a first optical fibre embedded in a solid resin material to form a first coated fibre bundle and a first extruded polymer sheath covering the first coated fibre bundle;
(b) providing a shorter, second length of cable comprising at least a second optical fibre and having a second extruded polymer sheath, said second length of cable having a leading end and a trailing end, and having a ferrule sub-assembly already fixed on its leading end, the optical ferrule being adapted to become, after installation through said duct, part of a pluggable optical connector for making an optical connection to the second optical fibre;
(c) forming a spliced joint between said first optical fibre at a leading end of the first length of cable and the second optical fibre at the trailing end of the second length of cable; and
(d) encasing the spliced joint in a protective body, the protective body being of diameter similar to or smaller than the ferrule sub-assembly and surrounding the spliced joint and surrounding portions of said first and second polymer sheaths either side of the spliced joint, the protective body.

The second length of cable may for convenience have the same form as the first length of cable. That is to say, the second optical fibre may be embedded in solid resin material to form a second coated fibre bundle, the second extruded polymer sheath covering the second coated fibre bundle.

Other optional features are defined in the appended claims, and further in the description and drawings.

The invention in the second aspect provides an accessory for encasing a spliced joint between optical fibres, the accessory comprising one or more parts that are adapted to be fixed around the spliced joint to form a generally cylindrical protective body with streamlined ends, the protective body optionally having an outer diameter less than 3.5 mm, optionally less than 3.0 mm, optionally less than 2.8 mm, and optionally having a length less than 40 mm, optionally less than 30 mm, optionally less than 25 mm, the protective body having an inner bore, the inner bore including a central portion for accommodating a spliced joint between first and second optical fibres, the inner bore further including first and second outer portions for surrounding portions of first and second polymer sheaths either side of the spliced joint, the inner bore optionally having a diameter at least in said outer portions that exceeds 0.6 mm, optionally exceeds 0.7 mm, optionally exceeds 0.8 mm, and optionally exceeds 0.9 mm.

The streamlined ends may be for example tapered or rounded or a combination of both. In some embodiments said outer portions of the inner bore have a diameter greater than said central portion.

In some embodiments, the accessory comprises two or more parts that are brought together to form the protective body (either before or after fitting to the spliced joint).

The accessory may include one or more ports by which a liquid can be introduced into the inner bore when said spliced joint is inside.

In some embodiments the protective body, excluding any sealant or bonding agent, is formed of a single material, optionally a metal or a thermoplastic material or a thermoset material having a tensile modulus in excess of 1500 MPa, optionally in excess of 2000 MPa, optionally in excess of 2200 MPa and optionally in excess of 2400 MPa, optionally having a yield strength in excess of 30 MPa, optionally in excess of 40 MPa.

The accessory can be applied in the implementation of the first aspect of the invention, or it may be used in other applications.

The invention in a third aspect provides a method of installing a pre-terminated optical fibre cable assembly made according to the first aspect of the invention set forth above, the method comprising the steps:
inserting the leading portion of said cable including said ferrule sub-assembly and said second length of cable into a duct; and
transporting a further length of the cable including at least a portion of the first length of cable through the duct until the leading portion of the cable protrudes from the duct; and
adding a connector body to the ferrule sub-assembly to complete said pluggable optical connector.

The invention in a fourth aspect provides a kit of parts for installing an optical fibre cable, the kit of parts comprising:
a pre-terminated optical fibre cable assembly according to the first aspect of the invention, set forth above; and
a connector body for adding to the ferrule sub-assembly to complete said pluggable optical connector.

In some embodiments, said pluggable optical connector is designed to pull out of a compatible adapter or socket with a force less than 30 N, optionally less than 25 N. this allows to realise the benefits of the present disclosure as well as the benefits of the unpublished patent application mentioned above

The above and other aspects of the invention will be understood by the skilled reader, from the consideration of the following description of exemplary embodiments.

### BRIEF DESCRIPTION OF THE DRAWINGS

Embodiments of the present invention are described below, by way of example only, with reference to the accompanying drawings, in which:

FIG. 1 is a schematic representation of a method of installing Fibre to the Home (FTTH), which includes installing a pre-terminated optical fibre cable assembly according to an embodiment of the present invention;

FIG. 2 is a schematic representation of a blowing process, as an example of how to install a pre-terminated optical fibre cable assembly according to an embodiment of the present invention;

FIG. 3 is a schematic cross-section of a fibre unit used in making the pre-terminated optical fibre cable assembly according to one embodiment of the present invention;

FIG. 4 is a schematic representation of a securing a pre-terminated optical fibre cable assembly according to an embodiment of the present invention to the duct after the leading end exits the duct;

FIG. 5 shows an assembled connector formed at the end of a pre-terminated optical fibre cable assembly usable in some embodiments of the present invention;

FIG. 6 is an exploded view of the connector of FIG. 5 showing parts of the connector housing, a protective boot, and an end of a pre-terminated optical fibre cable assembly including a ferrule sub-assembly;

FIG. 7 shows in more detail part of a pre-terminated optical fibre cable assembly usable in some embodiments of the present invention;

FIGS. 8 (a) to (f) are schematic views of an accessory including two parts for forming a protective body in some embodiments of the present invention, including a first part in views (a) to (c) and a second part in views (d) to (f);

FIG. 9 (a) to (c) are schematic representations of stages in the formation of a spliced joint with protective body, using the accessory of FIG. 8;

FIG. 10 illustrates schematically a method of assembling a pre-terminated optical fibre cable assembly according to some embodiments of the present invention;

FIG. 11 illustrates the schematically the fitting of a single-part accessory forming a protective body according to alternative embodiments of the present invention, including a preparatory stage in view (a) and a finishing stage in view (b);

FIG. 12 is a more detailed view of two parts for forming a protective body with ultrasonic welding of the parts;

FIG. 13 illustrates schematically an optical fibre cable assembly pre-terminated at both ends (a) with blowable ferrule sub-assemblies at both ends and (b) with a ruggedised connector at one end;

FIG. 14 shows in two steps (a) and (b) the installation of the cable assembly of FIG. 13 according to an application example;

FIG. 15 shows in two steps (a) and (b) the formation and installation of a series of cable assemblies, according to a further application example; and

FIG. 16 is a schematic cross section of a further example fibre optic cable that may be used in embodiments of the present invention.

### DETAILED DESCRIPTION OF EXEMPLARY EMBODIMENTS

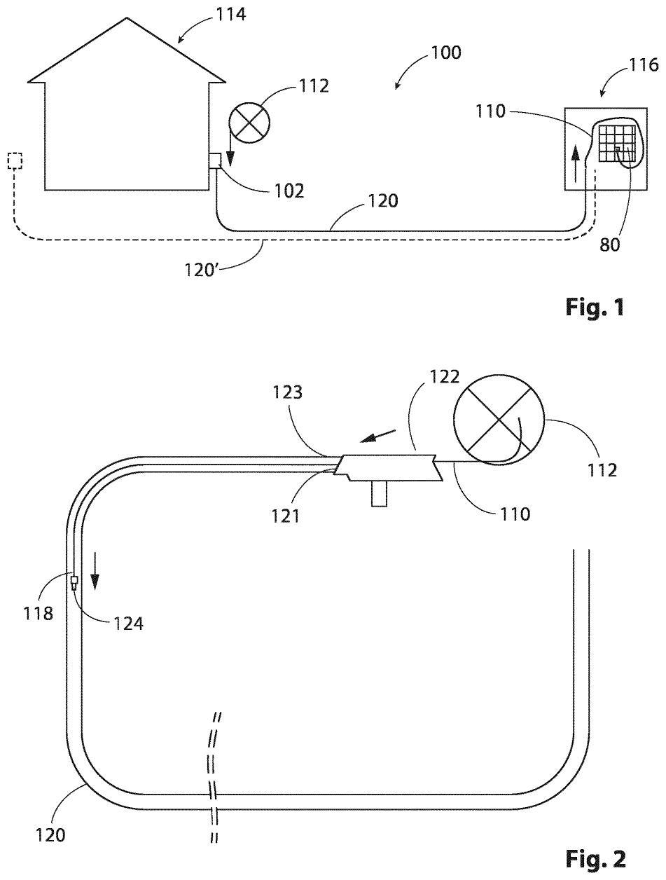

FIGS. 1 and 2 show an example of a Fibre to the Home (FTTH) installation 100 of optical fibres, using a length of fibre unit 110 as a lightweight, blowable optical fibre cable. It will be understood that terms such as “consumer” and “home” are used by way of example only, and the products and techniques described herein may equally be applied in commercial and industrial installations. As will be described in more detail below, one or both ends of the fibre unit has been terminated with a blowable connector component, typically a blowable ferrule sub-assembly 124 including an optical ferrule and a ferrule holder. The optical ferrule is installed on an individual one of the fibres, with the other fibre(s) in the bundle being spare for future use. In the illustrated example, a fibre unit is provided wound on a reel 112 from which pre-terminated optical fibre or fibres are delivered from an access point 102 on the exterior of a building 114, representing the consumer side/home side 114 of the installation 100 to the supply side, for example a telecommunications cabinet 116. Instead of a reel 112, the pre-terminated cable assembly may be provided in other forms, for example in a coil, in a fibre pan etc.

Referring also to FIG. 2, in the illustrated example the FTTH installation 100 is performed by passing a leading end of the fibre unit 110 into a pre-installed duct 120. Other ducts 120′ etc, lead from the same cabinet 116 to other premises, so that this installation method may be repeated many times in a neighbourhood.

FIGS. 1 and 2 show, by way of example, installation by blowing from the consumer side of the installation to the supply side. A leading end 118 of the pre-terminated fibre unit 110 is transported through the duct 120 at least partly by viscous drag created by compressed fluid, for example compressed air. A special blowing machine 122 has a blowing head 121 which is coupled to the receiving end 123 of the duct 120. It will be appreciated that the installation process may also be conducted from the supply side, for example a telecommunication cabinet 116, to the consumer side, according to convenience.

The leading end 118 of the fibre unit 110, which includes ferrule sub-assembly 124, leads the installation of the optical fibre or fibres through the duct 120. The leading end 118 passes through the duct 120 and a continuous length of fibre unit is fed from the reel 112 until the ferrule sub-assembly 124 and a length of the fibre unit 110 exits the duct 120 within the telecommunications cabinet (see FIG. 1). A protective cap (not shown) may be fitted over the ferrule 124 while the installation takes place. A connector housing (not shown in FIGS. 1 and 2 but described further below) may be added to the ferrule to make a complete connector for plugging into a mating socket or adapter. If desired, the fibre unit can be pre-terminated with the same or different connectors at both ends.

Particular forms of pre-terminated fibre optic cable assembly and methods of installation are disclosed in the earlier patent application WO2018146470A1 (Attorney's reference 11050PWO). The fibre unit in that disclosure is similar to a blown fibre unit disclosed in WO2004015475A2. A protective sleeve is added to the optical fibre before adding an ferrule sub-assembly to the leading end of the optical fibre. The protective sleeve extends for a distance of 1.5 m or so from a point behind the ferrule sub-assembly. When the cable is installed through a duct, the protective sleeve protects the portion of the fibre unit that protrudes from the end of the duct, for example in a communications cabinet. A residual length of the protective sleeve remains within the duct. By clamping the protective sleeve at one end into a connector body and at the other end into the end of the duct, the optical fibres within the fibre unit become protected against damage, where they are vulnerable outside the duct. The protection does not depend on the HDPE sheath of the fibre unit itself as a whole.

Embodiments of pre-terminated optical fibre cable assemblies according to the present disclosure may include a modified fibre unit having a sheath based on polybutylene terephthalate polymer (PBT). This modified fibre unit and other uses of it are described in another patent application WO2022049057A1. Embodiments of pre-terminated optical fibre cable assemblies according to the present disclosure may alternatively or additionally apply the teachings of United Kingdom patent application number 2111589.4, filed 21 Aug. 2021 and not published at the present priority date. This unpublished application proposes an alternative form of pre-terminated optical fibre cable assembly in which the added blowable sleeve is not required. The construction of the assembly of connector and fibre unit provides sufficient protection against damage and against pull-out forces in particular. Such an optical fibre cable assembly may include a modified fibre unit with PBT sheath, as described in WO2022049057A1. However, while the particular examples disclosed herein incorporate and build upon the teachings of those earlier applications, the invention disclosed herein is not limited to those teachings. Other types of connector, and other types of fibre unit sheath may be used.

Depending on the situation, including for example the length of connection required, blowing may be the most suitable method of installation. However, the present disclosure is not limited to blowing. An alternative installation process involves physically pulling the leading end 118 of the pre-terminated optical fibre cable assembly 110 through the duct 120 via the duct exit 120. For shorter installations, simply pushing the assembly through the duct may be practicable.

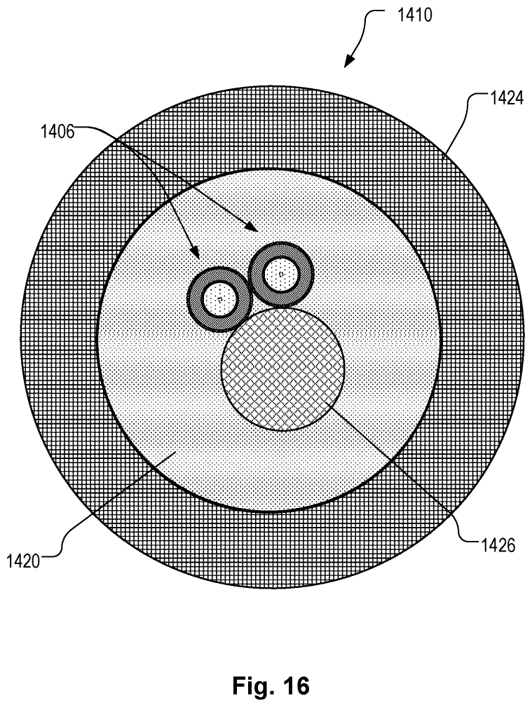

A protective cap may be fitted over the optical ferrule while assembly, stocking, transporting and/or installation takes place. In an embodiment where pulling is used instead of blowing, an adapter can be applied to provide a pulling eye and to protect the optical ferrule from damage during pulling. One example of such is described and illustrated in FIG. 16 of WO2022049057A1, mentioned above.

A fibre catcher (not illustrated) may be used to indicate when the leading end 118 of the optical fibre cable assembly 110 has reached its destination, that is, when the leading end 118 has exited the duct 120 and when a predetermined length of the optical fibre cable assembly 110 is within the cabinet 116. Alternatively, an installer may observe when the leading end 118 exits the duct 120, and communicate with the operator of the blowing machine 122 to cease blowing.

Comparing the example of the present FIGS. 1 and 2 with the disclosure of WO2018146470A1, it may be noted that there is no additional sleeve fitted over the end of the fibre unit 23, either before or after installation. That is because this particular example applies the principles disclosed in the unpublished patent application 2111589.4, mentioned above. In such an embodiment, the nature of the sheath of the fibre unit itself, and the manner of coupling the sheath to the connector, either before or after installation, result in an assembly which is strong enough to protect the fibres, even against forces strong enough to pull out the connector. The present disclosure is not limited to examples without the added sleeve, however. Protective sleeves can be provided or not, as desired.

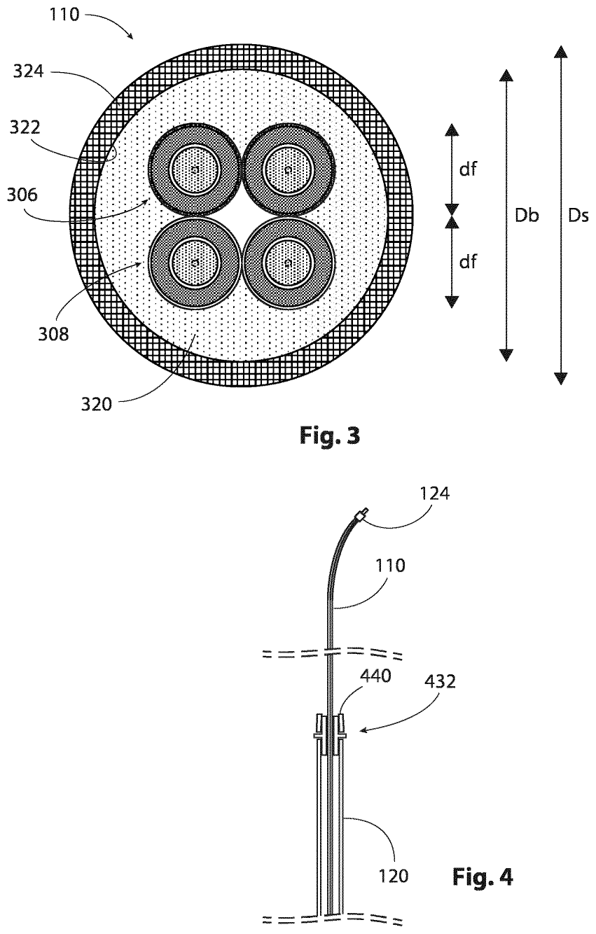

FIG. 3 presents shows in cross section an example of a fibre unit 110 used in the fibre optic cable assembly of FIGS. 1 and 2. The fibre unit 110 in these examples comprises a number of optical fibres 306 (at least one optical fibre) embedded in a solid resin material 320 to form a coated fibre bundle having an outer surface 322. The resin 320 comprises a radiation-cured resin, for example UV cured resin, for example an acrylate. The selected resin has a relatively high glass transition temperature, so that it is not rubbery, but rather solid as it encases the fibres 306 and locks them into a unitary structure. The elastic modulus of the resin material 320 is greater than 100 MPa, for example in the range 300 to 900 MPa, or approximately 300 MPa. Such a resin material 320 has a hardness (modulus) and tensile strength such that the individual optical fibres 306 are locked in a bundle, and substantially prevented from moving relative to one another, and/or relative to the resin material 320. On the other hand, the resin material 320 is not so hard and strong that it cannot be broken away from the fibres 306, when access to the individual fibres 306 is required for termination and/or splicing.

The coated fibre bundle in turn is surrounded by an extruded polymer sheath 324. This type of fibre unit 110 has a structure similar in many respects to a cable assembly of the type disclosed in published international patent application WO2004015475A2. Such fibre units have been designed, and used for many years, for installation by blowing with air or other compressed fluid. Fibre units of this type are known to blow hundreds and even thousands of metres, in microducts having a compatible low-friction lining. However, they can also be installed shorter distances by pulling and/or pushing, depending on the distance and the route involved. The outer sheath 324 is extruded onto the optical fibre bundle during manufacture of the fibre unit, which occurs in advance of manufacture of the optical fibre cable assembly. The outer sheath 324 protects the bundle and facilitates sliding of the bundle through the duct 120. The outer sheath in the known fibre unit for blowing is made of HDPE, with a friction reducing additive and optionally antistatic additives, colour etc.

While the HDPE sheath of the known blown fibre units is relatively thin and hard, relative to other blown designs available prior to WO2004015475A2, the sheath 324 according to the present disclosure may be significantly harder (stiffer) and/or significantly thinner than the sheath of the known fibre units. For example, the known HDPE sheath material may have a tensile modulus on the order of 1000 MPa (for example in the range 700 to 1300 MPa). According to example embodiments presented herein, extruded outer sheath 324 of fibre unit 110 can be based on polybutylene terephthalate polymer (PBT) which has a tensile modulus on the order of 2500 MPa, for example 2600 MPa. Even allowing for some reduction in the modulus caused by the inclusion of additives for reducing friction, imparting colour, antistatic properties and the like, the modulus of the sheath material may still be in excess of 1500 MPa, 2000 MPa, 2200 MPa or 2400 MPa. Likewise, the tensile strength (or tensile stress at yield) of the new sheath material can be significantly higher than that of HDPE. For example, tensile yield stress of HDPE is typically in the mid-20s MPa, while the tensile yield stress of PBT can be 50 MPa or more. The yield stress of the sheath material may be greater than or equal 30 MPa, for example, or 40 MPa or 45 MPa.

For installation by blowing, pushing and/or pulling, sheath 324 according to some embodiments comprises a mixture of polybutylene terephthalate polymer (PBT for short) and additional friction reducing and/or antistatic additives. Suitable commercially available PBT materials include grades of BASF Ultradur® 6550. Samples described herein have been made using BASF Ultradur® B 6550 LN in particular. Other grades of PBT may be used with suitable adaptation. Other grades of PBT may be used with suitable adaptation. For example, BASF Ultradur® B6550LNX is a high viscosity extrusion grade for microtubes in fibre optical cable applications, offering potentially thinner sheath. PBT is of course available from manufacturers other than BASF. The selected PBT material may already contain a certain amount of friction reducing material (“lubricant” in the manufacturer's terminology). As mentioned above though, some embodiments according to the present disclosure are made with additional friction reducing additive. The additional friction reducing additive may comprise a silicon-based lubricant, for example a siloxane such as polydimethylsiloxane-based additive, for example a polyacrylate dimethyl siloxane. An example of a polyacrylate dimethyl siloxane is Dow Corning® HMB-1103 Masterbatch, which is available commercially as a “tribology modifier for polar engineered plastics such as polyamide (PA) and polyoxymethylene (POM)”. As explained in WO2022049057A1, the applicant has found that siloxane-based additives having a polyolefin carrier can surprisingly be used to obtain friction reduction in the PBT sheath of fibre units, without causing problems in extrusion, that are experienced with the polyacrylate dimethyl siloxane. An example of this class is Dow Corning® MB 50-002 Masterbatch, which is available commercially as a formulation containing 50% of an ultra-high molecular weight (UHMW) siloxane polymer dispersed in low-density polyethylene (LDPE).

Whatever additive(s) are chosen, the amount of additive to be included can be determined during set-up tests of the extrusion process of the fibre units. As described in WO2022049057A1, the amount of additive may be between 1% and 5% by weight of the material of the extruded sheath, for example between 2 and 4%, more particularly between 2.5 and 3.5%. Aa value of 3% has been found suitable, bringing further enhancement in friction performance, without extrusion problems. The masterbatch MB50-002 has a loading of PDMS of 50%, which may be high compared with the (unknown) percentage in the HMB-1103. Based on the value of 50% and the inclusion of 3% of the additive as a whole, it will be seen that the overall siloxane content of the sheath material is around 1.5%, i.e. greater than 1%. For the purpose of the following examples and the reported testing, it is the PBT material with 3% masterbatch MB50-002 that will be used.

Having said that, PBT is not the only polymer that may be used as a base for the polymer sheath 324, and other polymers may offer the required the mechanical performance when combined with a coated fibre bundle and suitable termination components. As a further modification, the polymer sheath 324 in these examples may also be fully or partially cross-linked, for example to modify mechanical properties such as modulus (stiffness) and strength (yield stress), to improve dimensional stability and/or to improve high temperature performance. Other additives such as fillers, colouring, anti-static and the like may also be included.

To allow termination of individual fibres, it is necessary of course that they can be broken out from the fibre unit at the ends. By suitable control of the extrusion process, and selection of materials, the extruded outer sheath 324 can be prevented from bonding to the coated fibre bundle. This allows it to be cut and removed without damaging the outer surface 322 of the resin material, when stripping the fibre unit to access the individual fibres. Whereas the sheath of WO2004015475A2 is designed to be relatively loose so as to slide off the coated fibre bundle in long sections, the sheath of the modified fibre unit 110 can be relatively close-fitting, even tight. Suitable tools can be provided for making a longitudinal cut, so that the outer sheath can be split open and peeled off longitudinally, rather than being removed by sliding.

Various dimensions of the fibre unit and its components can be envisaged. The number of fibres 306 in a design such as shown in FIG. 3 can vary from as few as two to 4, 6, 8, 12 or even 24 fibres, similar to the applicant's existing range of blown fibre units. In the example illustrated, four optical fibres 306 are included in the resin bundle 320. These may be four signal-carrying fibres. Alternatively, the pair of fibres 308 shown with no colour in their outer coating layer may be “dummy” or “mechanical” optical fibres 308 which are included in the resin bundle only to provide mechanical stiffness and symmetry. This is a feature known from existing blown fibre units, and it is expected that this particular fibre unit may be better adapted for blown installation than one having only two fibres in total.

In one example, assuming that the diameter df of the four primary coated fibres is approximately 0.25 mm each, the diameter Db of the coated fibre bundle is for example 0.80-0.82 mm, and the diameter Ds of the fibre unit including the sheath 324 may be in the range 1.0-1.2 mm, for example 1.1 mm. The thickness of the sheath is accordingly about 0.2 mm, or less. The sheath 324 in this example is of PBT with a siloxane additive, for example an ultra-high molecular weight siloxane in an LDPE carrier, such as the one mentioned above. Note that coated optical fibres are now readily available in 0.2 mm diameter (200 micron), as well as 0.25 mm. Such smaller fibres can be used instead of 0.25 mm fibres in any of the designs contemplated herein, with a corresponding reduction in the size of all layers, if desired.

A single such fibre unit, without being encased in any other structure, is found to be suitable for use as a fibre optic cable suitable for installation in microducts by means of blowing. As is known for the known blown fibre unit (WO2004015475A), the embedding of the optical fibres in a relatively solid resin provides a stiffness to the structure of the fibre unit, independent of the stiffness of the outer sheath. With the increased strength, hardness and stiffness of the PBT material relative to HDPE, a fibre unit better suited to pushing and pulling can be provided. Additionally, a fibre unit well suited to installation by blowing can be provided. The thickness and detailed composition of the PBT or other sheath material can be adjusted and optimised for one particular installation method, or chosen to perform satisfactorily across a variety of installation methods. To favour blowing, a thinner sheath can be provided, which is nevertheless a robust protection for the fibres contained within, and does not interfere with blowing performance.

In a specific example designed for blowing, dimensions are as shown approximately to scale in FIG. 3, the diameter Db of the coated fibre bundle is again 0.80-0.82 mm, but the diameter

Ds of the product including the sheath 324 is around 1.05 mm. The thickness of the sheath is accordingly about 0.115 mm, somewhat thinner than in the examples of the prior art. The sheath 324′ in this example is of PBT with a siloxane additive, for example an ultra-high molecular weight siloxane in an LDPE carrier, such as the one mentioned above. Thanks to the inherent stiffness and strength of the PBT-based material, as well as the very low friction properties of the material, the sheath can have a thickness substantially less than 0.2 mm, for example less than 0.15 mm or less than 0.13 mm. Thickness in the range 0.05 to 0.25 mm can be envisaged.

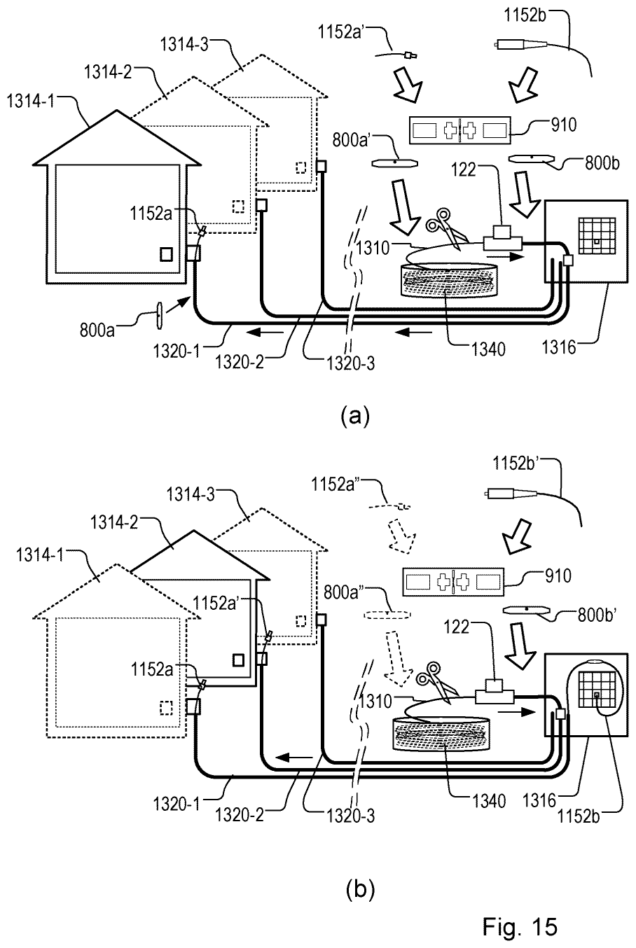

On the other hand, (as mentioned already above) a single design of fibre unit can have a satisfactory degree of performance in pushing, pulling and blowing. A particular variant is described below and illustrated in FIG. 15.

With reference now to FIG. 4, after the leading end 118 of the fibre unit 110 exits the duct 120, installation at the telecommunications cabinet 116 is completed by plugging the open end of the duct 120 with a plug accessory connector 432 that has an outer diameter that is configured to be a push-fit into the duct 120 and has a hollow or groove into which the fibre unit containing the optical fibres is received. A capping sleeve 440 is operable to locally compress the plug accessory 432 against the fibre unit sheath to prevent fibre unit movement after installation of the optical fibre cable assembly. More detail of this accessory is provided in WO2022049057A1.

### Blowable Connector Examples

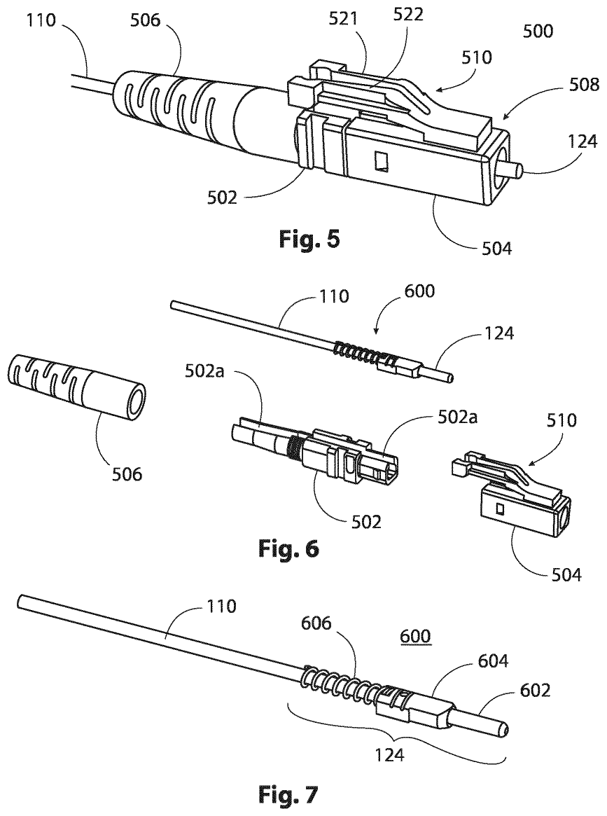

FIG. 5 illustrates in more detail one example of a connector 500 that may be used at the leading end of the pre-terminated optical fibre cable assembly 110. Visible at the right hand end is the tip of an ferrule sub-assembly 124. The ferrule sub-assembly 124 is of a size suitable for installation through the duct 120, and does not form a complete connector assembly 500 until other components are added. The LC connector is the most common type for use in a congested setting like the street cabinet 116 of FIG. 1, for example. The conventional LC connector, however, is designed to snap-lock and not withdraw until the latch is released by deliberate user actuation. Consequently, it is also a common hazard that installed cables are liable to be pulled accidentally and damaged by destructive forces. In the illustrated example, the connector body is made according to principles disclosed in published United Kingdom patent application GB2589365A. This type of connector defines a limit to the pull-out force required to remove the connector from a socket. The connector 500 illustrated in FIG. 5 is designed to mate with another LC connector in a standard LC type adapter. (In effect, the fitting one connector in the adapter forms a socket for the mating connector to plug into. The terms “socket” and “adapter” may therefore be used interchangeably for the purposes of the present disclosure, except where the context requires otherwise.)

The connector 500 comprises, in addition to ferrule sub-assembly 124, a connector rear body 502, a connector front body 504 and a flexible boot 506 from which the fibre unit 110 emerges.

These parts are locked together to form a connector body 508. A latch mechanism 510 comprises one or more resiliently deformable latch members. When the connector body is latched into a corresponding adapter (not shown here), the connector can be unlatched by manual actuation, so allowing the withdrawal of the connector 500 from the adapter. Following the teaching of GB2589365A, however, the latching mechanism 510 is designed to disengage from the adapter without user intervention, when a sufficient force is applied in a direction parallel to the longitudinal axis of the connector 500. A force of 20 N or above may overcome the resilient bias of the latch mechanism 510 and remove the connector 500 from the adapter 110. therefore, the risk of permanent deformation or failure of the connector or cable when large forces act upon the connector, such as accidental forces, is greatly reduced.

FIGS. 6 illustrates part of a fibre optic cable assembly 600 prior to installation including a blowable fibre unit 110 of the type illustrated in FIG. 3 and a ferrule sub-assembly 124 coupled to one optical fibre 306 of the fibre unit 110. For installation in a 3.5 mm duct, for example, the ferrule sub-assembly may be less than say 2.8 mm, at its widest dimension. The ferrule sub-assembly used commercially at present has a maximum dimension of 2.65 mm, for example. After installation through a duct 120, the assembly is combined with the connector rear body 502, connector front body 504 and boot 506 to form a cable with connector as seen in FIG. 5. The cable assembly with these parts 502, 504, 506 may be supplied together, as a kit of parts. Whatever type of connector is used, the fixing of the cable within the connector needs to protect the optical fibres from being subjected to any tensile force greater than 5 N, or the connection may be destroyed. This is the reason why most pluggable cables have reinforcing yarns of aramid (Kevlar®) or the like which can be anchored to the connector body, and why the blown fibre unit of WO2018146470A1 has the additional sleeve to protect the length of fibre unit between the connector and the duct. In an example incorporating the teaching of unpublished UK patent application number 2111589.4, the construction of the assembly exploits the superior mechanical properties of the PBT-based sheath 324 to protect the fibres against undue forces without the provision of strengthening yarns or added sleeves. According to that unpublished application, the sheath is bonded to the ferrule sub-assembly 124 so as to resist pull-out forces greater than the limited pull-out force set by the special latching mechanism 510, disclosed in GB2589365A, mentioned above.

GB2589365A proposes a minimum removal force of between 15N and 30N is required to overcome the resilient bias to remove the fibre optic connector from a fibre optic adapter, with a removal force of 20N being a preferred threshold required to overcome the resilient bias to remove the fibre optic connector from a fibre optic adapter. LC is only one type of connector, of course. Another common type of connector is the larger SC (subscriber connector) type connector, which may also be designed to pull out with a force lower low enough to ensure no damage between the optical fibres and the ferrule. The pull-out force of the modified SC connector may be for example about 20 N, with a maximum of 25 N, say. Conventionally, an SC type connector might be provided on the premises end of the cable, but it is also becoming common for the smaller LC connectors to be used at both ends.

As seen enlarged in FIG. 7, the ferrule sub-assembly 124 in this example comprises a generally cylindrical optical ferrule 602 supported by a ferrule holder 604 and a spring 606. Ferrule holder 604 is shaped with keying surfaces to ensure accurate alignment of the optical ferrule 602 with the connector axis, where it will mate with a complementary ferrule in the socket. As is known, the end surface of the optical ferrule, with the optical fibre embedded in it, can be ground and polished either flat or at an angle. The spring 606 is for biasing the optical ferrule into engagement with the optical ferrule of a mating connector to ensure a good connection. In principle, only one of the connectors needs to have the spring biasing, while the other one could be rigid. In practice, design and manufacturing tolerances will be greater when a spring is provided, and the inclusion of a spring avoids any concern that a mating connector might be rigid.

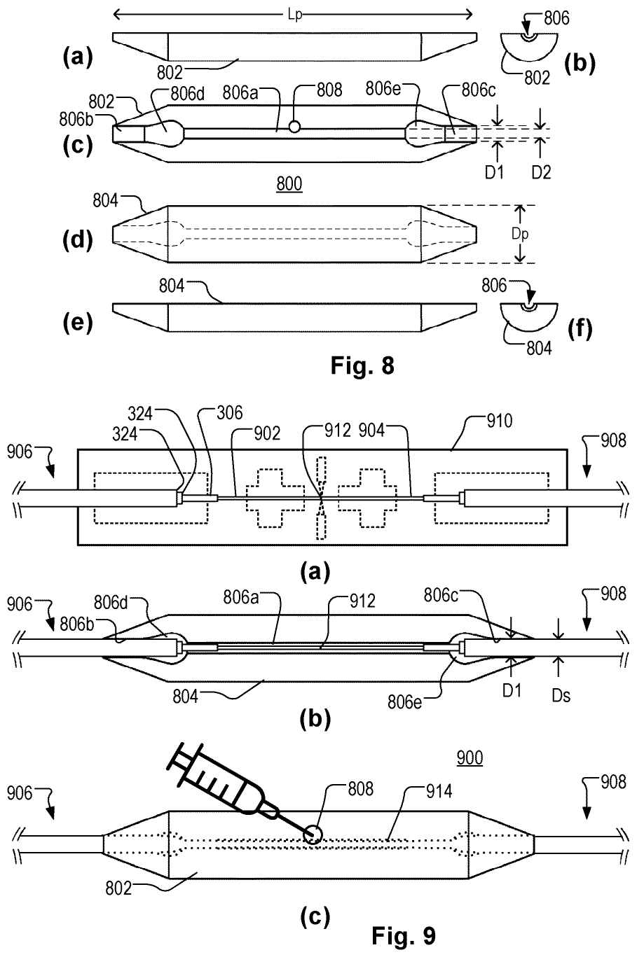

It will be understood that, while the cable may carry more than one optical fibre, for example 2 or 4 optical fibres, in the majority of installations, only one of these fibres carries live signals, and only that one is provided with a ferrule sub-assembly 124. The unused fibres are used, when necessary, as backup. In the assembly 600, a selected one of the optical fibres 306 is inserted into the bore of the optical ferrule 602 and cemented there using, for example, an epoxy resin. So much is common to all optical ferrule connectors. Additionally, in embodiments using the modified fibre unit with PBT-based sheath, not only an optical fibre but also a portion of the outer sheath 324 can be fixed in the optical ferrule and/or the ferrule holder 604, again with epoxy resin or another adhesive. In this way, ferrule holder 604 is made to serve also as a restraining part for transferring tensile forces from the trailing cable 110 to the connector body, after installation. This process is illustrated in more detail with reference to FIG. 8 in the unpublished patent application. As also illustrated in the unpublished patent application, an additional or alternative restraining part can be adhered to the sheath, behind the ferrule sub-assembly.

For the purposes of the present description, it will be assumed that there is only one active fibre 306, and only one ferrule sub-assembly 124, 602, 702 etc. However, it is not excluded that two or more optical ferrules (not illustrated) can be simultaneously connected to two or more individual optical fibres within the cable assembly. In one specific example, known from GB2509532A, each ferrule holder 604 is D-shaped in cross-section. The flat portions of the D-shaped bodies are abutted such that the combined dimension of the abutted bodies is small enough so both ferrule bodies can pass together through a duct when nestled side-by-side in a suitable caddy. Other duplex and multiplex connectors are known which can be adapted also for use in cable assemblies according to the present invention. For example, dual ferrules can also be arranged longitudinally staggered for installation. The flat portions of the D shape in the illustrated examples provide for precise location and orientation of the fibre in the connector body, regardless of whether the option to terminate two fibres is exploited. As another example, multi-fibre push-on (MPO) connectors in which multiple fibres are terminated in parallel in a line array arrangement can be envisaged, within the scope of the present disclosure. MPO connectors with 8, 12 and 24 fibres are known.

### Blowable Splice Protector

FIG. 8 illustrates schematically an embodiment of an accessory for encasing a spliced joint between optical fibres. The accessory 800 comprises a first part 802 and a second part 804 that are adapted to be brought together and fixed around the spliced joint to form a single protective body 800. The outer diameter Dp of this body will be small enough to be installed without difficulty along with the fibre unit and the ferrule sub-assembly 124. The diameter Dp may therefore be less than 3.5 mm, optionally less than 3.0 mm, optionally less than 2.8 mm. The protective body 800 may have dimensions of length and/or diameter similar to, if not smaller than, the ferrule sub-assembly 124. The protective body 800 may have a length Lp less than 40 mm, optionally less than 30 mm, optionally less than 25 mm.

As can be seen from the orthogonal views (a) to (c) of first part 802 and orthogonal views (d) to (f) of second part 804, the parts are substantially mirror images of one another, each having a generally half-cylindrical form. Each part 802/804 has a half-circular channel so as to define, when assembled having a circular inner bore 806. The bore 806 and portions of it are labelled for convenience on the first part 802 only. The inner bore in this example has a central portion 806a with diameter D1 for accommodating a spliced joint between first and second optical fibres. The inner bore is further provided with first and second outer portions 806b and 806c . These outer portions have a greater diameter D2 for surrounding portions of first and second polymer sheaths either side of the spliced joint. Between the central section and each outer section, enlarged well portions 806d and 806e for bonding agent.

It will be seen that the protective body formed by the parts 802 and 804 will be generally cylindrical but with tapered ends. The tapered ends are to facilitate progress of a protected spliced joint into and through a microduct, as will be described below. The best streamlined shape for a given application can be determined by experiment. Examples include may be a simple taper, as shown, or a rounding. In one embodiment, the overall length Lp of the protective body is around 23 mm, of which each tapered end occupies 3 or 4 mm.

In the illustrated embodiment, the first and second parts 802 and 804 are separate from one another until brought together. Alternatively, they could be hinged. The illustrated parts are substantially flat-faced halves in the example. Alternatively, they could have non-flat profiles for mating together in a keyed manner. (FIG. 12, described below, illustrates a version with mating formations adapted for ultrasonic welding.) The parts can be formed of material, optionally a metal or a thermoplastic material or a thermoset material, cast or moulded. They may be machined or formed by additive printing. If plastic, a low-friction material will be preferred, and there may be included a friction-reducing additive. For metal, metal injection moulding (MIM) can be used to form intricate parts, including a one-piece accessory, as described further below.

The first part 802 also provides a port 808 by which a liquid bonding can be introduced into the inner bore. More than one port can be provided in one or more of the parts.

FIG. 9 illustrates steps of forming a protected spliced joint 900 between a first optical fibre 902 and a second optical fibre 904. The first optical fibre 902 is one of the optical fibres embedded in resin in a first length of optical fibre cable 906 and the second optical fibre 904 is one of the optical fibres embedded in resin in a second length of optical fibre cable 908. Each optical fibre cable in this example is a fibre unit of the general form shown in FIG. 3.

Labels the same as in FIG. 3 will be used to identify the corresponding parts of the first length of cable 906 in FIG. 9. In a preparatory step, the ends of the fibres 902 and 904 have been exposed by removing a length of the extruded polymer sheath 324 from each cable 906, 908. Next, the resin coating 320 of the fibre bundle is removed to expose the primary coated optical fibre 306 of the desired colour. Then the primary coating of the fibre is removed to expose the glass of the first optical fibre 902.

The same preparation is done to expose the glass of the second optical fibre 904, as shown in FIG. 9(a), and then the prepared ends are mounted in a splicing tool 910, which the skilled reader will recognise as a conventional fusion splicer. The tips of the first and second optical fibres 902 and 904 are brought into precise alignment and fused together, typically with electric arc power. Thus, a spliced joint 912 is formed between the optical fibres 902 and 904.

FIG. 9(b) shows next steps for encasing the spliced joint 912 in a protective body 800 formed using the parts illustrated in FIG. 8. The second part 804 of the accessory is placed so as to support spliced joint 912 in the central portion 806a of the bore 806. The preparation of the cable ends is such that the outer portions 806b and 806c receive portions of the extruded polymer sheath either side of the spliced joint.

Then as seen in FIG. 9(c), the first part 802 of the protective body 800 is mounted to the second part 804 and a filling and a liquid boding agent is injected through port 808 to fill the inner bore 806, or at least some of it. The bonding agent may serve also as the filling. As well as giving strength, the filling protects the exposed glass from the atmosphere, which would degrade the glass over time. The filling may therefore also be referred to as a sealant. By application of heat and time, the liquid bonding agent is cured to become a hard solid, and the protected spliced joint 900 is complete. The bonding agent may extend through all sections of the bore 806, as indicated by the dotted lines 914, or only some portions. Bonding agent may also extend over the mating surfaces of the first and second parts 802, 804, so that they become a single protective body for the spliced joint. Alternatively, the two (or more) parts of the protective body may be fused or bonded in a different way, before the bore is filled. Likewise, the parts of the body may be fused or bonded to the extruded sheath 324 in a different way, before the central portion 806a of the bore is filled. A jig may be provided for assembling and/or clamping the parts together during injection and curing of the bonding agent.

While a syringe is illustrated schematically, for volume production, the skilled person will understand that the resin will be applied in practice using a precision dosing tool of the type available commercially. Quantities, speed of injection, curing conditions and the like can be determined by experimentation, cutting the finished protected splice joint and inspecting it to confirm the required penetration, curing and so forth. Dosing tools which mix two-part resins and deliver a precise dose are available commercially, for example from ICSRA Dielectrics Srl of Conegliano, Italy.

The inner diameter D1 of the bore portions 806b and 806c can be tailored to the outer diameter Ds of the fibre units with sheath 324 in a number of ways. In some embodiments, the diameter D1 is slightly less than the diameter Ds, so as to make a tight fit and provide a mechanical clamping action between the protective body and the sheath. For example, the bore diameter in portions 806b and 806c may be 1.0 mm, for a cable with sheath diameter 1.1 mm. In other embodiments the diameter D1 may be matched more or less exactly to the sheath diameter Ds, to provide an interference fit. In other embodiments, the protective body may be a loose fit (D1<Ds), with a gap filled by bonding agent. Bonding agent (adhesive) can be applied before mating these parts, if desired, as well as or instead of injecting it through port 808. Additional ports (not shown) can be provided elsewhere in the body 800, for example to allow additional injection points, or to allow escape of air while injecting as shown.

Throughout this description, it is assumed that the cables 904 and 906 either side of the spliced joint are identical in dimension and in form. This is not necessarily the case, however. One of them may contain more or fewer optical fibres, since only one or two of the optical fibre are likely to be active anyway. One of them may have strengthening elements, and/or different sheath diameters. The protective body in such a case may be asymmetrical in its inner and/or outer diameters, without deviating from the principles of the invention disclosed herein.

On completion of the steps described above and illustrated in FIG. 9, there is provided a spliced joint 900 with protection against damage during and after storage, transport and installation operations. Compared with conventional splice protectors, which have the form of a steel rod within a length of heat-shrink tubing, the protective body is more compact in both dimensions, lightweight, and streamlined, so that it can be incorporated in a cable assembly prior to installation in microducts by blowing or other methods. This aspect of the present disclosure is useful in its own right. However, as will now be described, it can be used to improve the efficiency and reduce the cost of manufacture of pre-terminated optical fibre cable assemblies, such as described above with reference to FIGS. 1 to 7.

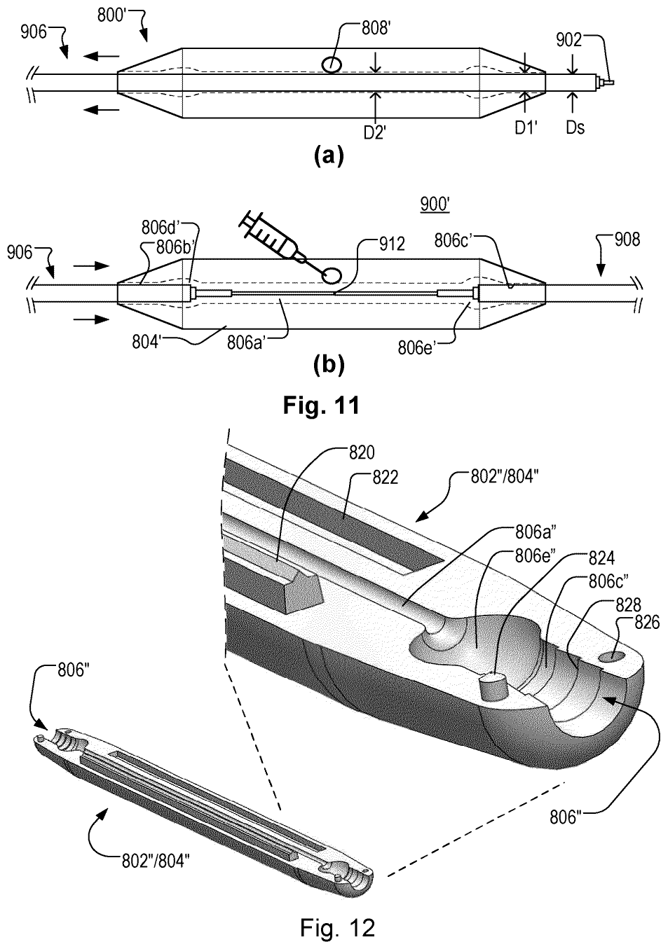

Some alternative embodiments of the protective body and the method of applying it will be described below, with reference to FIGS. 11 and 12. Before that, we will describe the method of assembling a complete pre-terminated optical fibre cable assembly using the accessory and method of FIGS. 8 and 9.

### Pre-Terminated Optical Fiber Cable Assemblies with Protected Spliced Joints

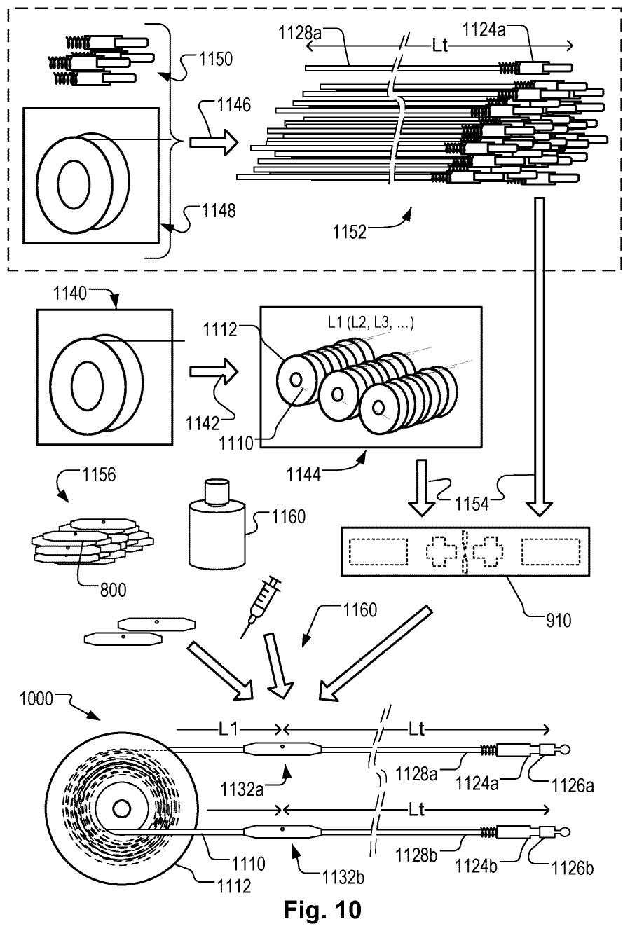

FIG. 10 illustrates a method of assembling a pre-terminated optical fibre cable assembly 1000 configured to be installed through a duct. Adding prefix ‘1’ to the reference signs of FIG. 1, for example the finished assembly comprises an optical fibre cable comprising a length of fibre unit 1110 of the general form shown in FIG. 3, wound upon a reel 1112. A first ferrule sub-assembly 1124a is provided at a leading end of the cable 1110, with a protective cap 1126a illustrated as well. A second ferrule sub-assembly 1124b is provided at an opposite end of the cable 1110, with a protective cap 1126b illustrated as well. The leading end of the cable assembly for the present description is the one wound to the outer radius of the reel 1112. It goes without saying that the opposite end of the cable can become the leading end, if it too is to be installed in a duct. The skilled reader will appreciate that the reel 1112 is not shown to scale. It may have a diameter such as 20-30 cm, while the fibre unit has a diameter 1-2 mm and the ferrule sub-assemblies have diameter only 2-3 mm.

The overall form of the assembly and its manner of use are substantially the same as the assemblies disclosed in the prior patent applications WO2018146470A1 and 2111589.4, mentioned above. However, the method of manufacture which is performed in a factory environment, prior to installation in said duct, is different. As a consequence of the difference in manufacture, it will be seen that the main length of fibre unit 1110 with length L1 at its leading end is coupled to the ferrule sub-assembly 1124a via a “tail” length of fibre unit 1128a with length Lt and a first protected spliced joint 1132a. In the illustrated example, the main length of fibre unit 1110 with length L1 at its opposite end is coupled to the second ferrule sub-assembly 1124b via a second “tail” length of fibre unit 1128b and a second protected spliced joint 1132a. In the illustrated example, the ferrule sub-assemblies at both ends of the assembly are identical ferrule sub-assemblies, adapted for installation into ducts by blowing or other methods. The tail lengths, and protected spliced joints are also identical in this example. In practice, however, they may be different in any or all characteristics, according to the particular use case.

At first sight, this modified cable assembly requires more manufacturing steps and components than the known one, due to the introduction of one or more spliced joints and splice protectors. However, as will now be explained, introducing this complication in the structure in fact enables a more streamlined and efficient manufacturing process, where such assemblies are to be manufactured in high volume.

Referring to the upper half of FIG. 10, the manufacturing steps are illustrated as follows. From a first supply of fibre unit 1140, a first length L1 of cable is cut and wound onto reel 1112 in an operation labelled 1142. The length L1 may be a few tens or hundreds of metres, while the supply is in pans or reels of thousands of metres. For mass manufacture, in the same process step 1142, numerous reels can be loaded with appropriate reels can be loaded with appropriate lengths of cable to create a supply of first lengths of cable 1144 for use in manufacturing numerous pre-terminated cable assemblies. They may all have the length L1, or they may be different lengths L2, L3 etc.

In a parallel operation labelled 1146, shorter lengths of cable 1128 are cut from a second supply of fibre unit 1148 and fitted with respective ferrule sub-assemblies from a supply 1150. This creates a supply of pre-terminated “tails” 1152. One of these shorter lengths of cable has the tail length Lt and can be used as the second length of cable 1128a with first ferrule sub-assembly 1124a in the manufacture of cable assembly 1000. Another of these shorter lengths of cable can be used as the third length of cable 1128b with second ferrule subassembly 1124b. The tail length Lt, which may be the same for all or different for different uses, may be on the order of a metre or a few metres, for example being less than 10 m, or less than 3 m, optionally greater than 1 m, for example 2 m. The tail length may alternatively be less than 1 m, for example at little as 10 cm or 20 cm. In any case, this shorter length Lt, contrasts with the first length of cable L1, L2 etc., which will typically be greater than 10 m, for example in stock lengths of 25, 50, 75, 100, 150, 200 m etc.

After the supplies of reels and pre-terminated tails have been prepared, to manufacture each cable assembly 1000 a first length of cable 1110, already on its reel 1112 is taken from the supply and in an operation 1154, a spliced joint is formed between a first optical fibre at a leading end of the first length of cable and a second optical fibre which is at the trailing end of the second length of cable 1128a, taken from the supply 1152 of pre-terminated tails. This operation corresponds to step (a) in the method of FIG. 9 and uses the fusion splicing tool 910.

Also provided at this stage is a supply 1156 of accessories of the type illustrated in FIG. 8, and a supply 1158 of bonding agent. In an operation 1156, the spliced joint is encased in a protective body 1132a, according to steps (b) and (c) of the method of FIG. 9. As already described above, the protective body may be of diameter similar to or smaller than the ferrule sub-assembly. It may surround not only the spliced joint but also surrounding portions of the polymer sheaths either side of the spliced joint. In this example, portions of the sheath either side of the spliced joint are bonded to the protective body by a bonding agent provided within a bore of the protective body. As described already with reference to FIG. 9, various alternative approaches are possible, to ensure that the protected spliced joint is not only small enough to be installed subsequently in a micro-duct but also protects the fibres and the spliced joint itself from undue forces of tension and/or bending. For example, by clamping and/or bonding the protective body to the sheath, the cable assembly in the region of the spliced joint can be subjected to tensions in excess of 20 or 30 N, while protecting the fibres within from any force exceeding 5 N. This is particularly the case when the stronger PBT-based sheath material is used.

The bonding agent may be for example an epoxy resin. Implicit but not illustrated for reasons of space is the curing operation, which operates by time and/or elevated temperature. In principle, other means of fixing these components together may be deployed, aside from cured epoxy resin. Other types of adhesive may be deployed, and/or mechanical coupling such as by ridges, crimping or the like, and/or other joining methods such as ultrasonic welding. In the illustrated examples, the use of a cured epoxy resin is convenient and avoids the risk of mechanical damage and/or micro-bending losses.

While field-installable splices and even field-installable ferrule connectors are known, it will be understood that the entire cable assembly 1000 can be prepared in a factory environment. This allows maximum use of cleanroom environments, mass production equipment and methodology, and highly trained personnel for assembly and testing. Moreover, by separating the operation 1146 of fitting the ferrule subassemblies from the operation 1142 of creating the desired reeled lengths of cable, even greater efficiency is achieved. This is because the short second lengths of fibre unit can be handled much more easily and in a smaller space than the longer, pre-reeled lengths. This is further and in particular because the termination of these tails with the ferrule subassemblies 1124a etc. is delicate and time-consuming. A large number of pre-terminated tails can be prepared to a high standard much more easily than would be possible with the conventional approach of applying the ferrule subassembly to a larger, reeled length of cable. One reason for this is that a polishing operation is generally involved, which is time-consuming in itself, but can be performed simultaneously on a group of, say 16 or 24 ferrules. To arrange such parallel treatment with short tails is much easier than it would be with bulky reels attached. This observation may, in itself, not be new. However, without the blowable splice protector and methodology described herein, it would not be applicable in the production of pre-terminated cable assemblies for installation through microducts.

The operations 1142 and 1146 can be separated in space and/or in time. That is to say the operations can be performed in different parts of a factory, or even in different factories, to maximise efficiency. For example, the supply 1152 of pre-terminated tails may be manufactured at a central location, and then divided and shipped to multiple factories local to different markets, where they can be combined with locally produced reels 1112 of cable. Additionally, it will be understood that a supply 1152 of pre-terminated tails may be manufactured speculatively before it is known what combination of customised lengths L1, L2, L3 etc. of pre-terminated cable assemblies will be required. The overall cost of manufacture, as well as the lead time to delivery of the finished cable assemblies, can be reduced.

Alternatively, as will be illustrated below with reference to FIG. 15, the supply of pre-terminated tails may be manufactured at a central location and then divided and shipped to field locations where pre-terminated cable assemblies are to be manufactured immediately prior to installation. Benefits of this approach include the ability to produce assemblies as and when they are needed, and reducing wastage that may be associated with manufacturing standard lengths instead of custom lengths.

As already mentioned above, the fibre unit used either side of a spliced joint may be a fibre unit exactly the same, or it may be different. So long as the optical fibre or fibres which are terminated in each ferrule subassembly are spliced to the correct optical fibre, the assembly will carry signal from one end of the complete assembly to the other.

The cable assembly 1000 can be made into a kit of parts with the addition of connector body parts (parts 502, 504, 506 or the like), capping and sealing accessories (432, 440) or the like.

FIG. 11 illustrates the schematically the fitting of a single-part protective 800′ forming a protective body according to alternative embodiments of the present invention. Parts corresponding to those shown in FIGS. 8 and 9 are given the same labels, with a “′” appended. In a preparatory stage illustrated in view (a), the first length of cable 906 has been cut, but not yet prepared for splicing. Protective body 800′ is in one piece and is slid bodily onto the first length of cable in the direction of the arrows. As illustrated, the inner bore of the protective body has diameters D1′ and D2′ in its outer and central portions, respectively, that are sufficient to allow the cable with outer diameter Ds to pass throughout the entire length of the protective body 800′.

As seen in view (b), after a spliced joint 912 is made between the lengths of cable 906 and 908, protective body 800′ is slid in place over the spliced joint, and its internal spaces filled with resin as before. The quantity of resin will be greater than before, to fill the wider internal space 806a′. The quantity of resin and its speed of injection will be controlled by a suitable dosing apparatus, as described above. After the resin has cured, a protected spliced joint 900′ has been formed, which may be substantially the same, externally, as the protected spliced joint 900 of FIG. 9.

FIG. 12 is a more detailed view of two parts for forming a protective body according to a further example. Parts corresponding to those shown in FIGS. 8 and 9 are given the same labels, with a “' appended. One half is shown, which could be first part 802” or second part 804″, with half-cylindrical sections of inner bore 806″. Of the part is shown, it being understood that the other end is a mirror image of the same. Rather than being flat faced, each part is formed with projections 820, 824 and recesses 822, 826 which provide a keying function, when two of the identical halves are mated face-to-face. Moreover, in the example shown, the projections are formed with spiked or rounded energy directors, designed in a known manner for ultrasonic welding. When the energy director contacts a facing plastic part and is subjected to vibration from a suitable ultrasonic welding head, ultrasonic energy melts the point contact between the parts, creating a joint. With ultrasonic welding of the parts instead of adhesive bonding, the time required to make a solid joint can be greatly reduced.

Sealant, filler and/or bonding agents may be included to protect the glass fibres within the inner bore 806a″ can be taken, as in the previous examples. A port or ports 808″ can be included, not shown in this drawing. Curing of the material, for example an epoxy resin, may occur during assembly, or may happen over an extended period after the quick assembly by ultrasonic welding. Enlarged well portions 806d″/806e″ can be provided or not, as desired stop. Also illustrated in this example is the option to include retention features 828 with a barb-like profile, to engage the sheath of the cable, and resist tensile forces. These retention features, which may be used equally in the examples described above, may be used instead of or in addition to bonding to the sheath material.

In use, the two parts 802″ and 804″ can be brought together around a spliced joint, in the same manner as described above with reference to FIGS. 9 and 10. Additionally, forming two parts and joining them into one part by ultrasonic welding could be performed in advance, to produce a one-piece accessory of the type illustrated in FIG. 11. These and many other variations in the design and manufacture of such an accessory are within the capability of the skilled person to envisage and realise.

Additionally, while the above examples involve the provision of a protective body from one or more prefabricated parts, cable assemblies according to some aspects of the present disclosure can be formed without a pre-fabricated accessory. In such embodiments, after the spliced joint is formed, a protective body can be formed around the spliced joint, for example by injection moulding, casting and the like. Such a body may be made of a thermoplastic or thermosetting plastic, optionally with reinforcing fibre material and/or fillers. Materials of the protective body may be bonded or even fused with the material of the cable sheath at one or both sides of the spliced joint, according to the particular materials and techniques used. So-called “desktop moulding” apparatuses are commercially available. Protective gel or resin may be applied to the spliced fibres in advance of the moulding step, if required. The resin may be cured by time, temperature, UV radiation or a combination of these. Whether the protective body is formed by casting, moulding or some other method, the external form of the protected spliced joint formed in such examples can be similar to the external form of the protected spliced joint formed using prefabricated accessories, as described above.

### Retention (Pull-Out) Tests

Retention and pull-out tests can be performed whether an optical fibre cable assembly including a spliced joint such as the example 1000 described above has a tensile strength (pull out strength) sufficient to protect the optical fibres in the manner described above. Such tests can be adapted from those known in the art, and those described more particularly in the prior patent applications WO2018146470A1 and 2111589.4, mentioned above.

### Blowing Performance Tests

As explained already, cable assembly 1000 can be optimised for installation by blowing. As a first test for suitability for blowing installation, friction tests can be performed as described in the prior patent applications WO2022049057A1 WO2018146470A1 and 2111589.4, mentioned above. In the real world, blowing performance in a real application depends on many variables as well as the coefficient of friction. Various different testing regimes of blowing performance are known and used in the industry, including standard tests and custom tests for individual manufacturers and/or customers. A long-established test, and one which is generally very challenging for blown fibre products, is the 500 m drum test.

As mentioned, the cable assembly of the type disclosed herein can be installed by blowing, or by pushing, pulling, or by a combination of these processes. For pulling, it may be noted that ducts can be purchased which are pre-loaded with a pulling line.

As is known by the skilled person, the distance that a length of optical fibre cable that can be installed by pulling or pushing may be significantly less than the distance that can be obtained by blowing, but it may be adequate, for example for short drops within a building, or from street to building. Providing a versatile cable assembly that can be used in two or three different modes of installation allows installation to be performed by a mixture of blowing, pulling and pushing, for different segments of a single building or district network. This avoids, for example, being forced to use complicated blowing procedures for even the shortest drop, or having to specify different types of cable for different segments. Pre-terminated assemblies can be provided in a mixture of different lengths, tailored to the particular combination of lengths required in a particular installation job.

### Example Application

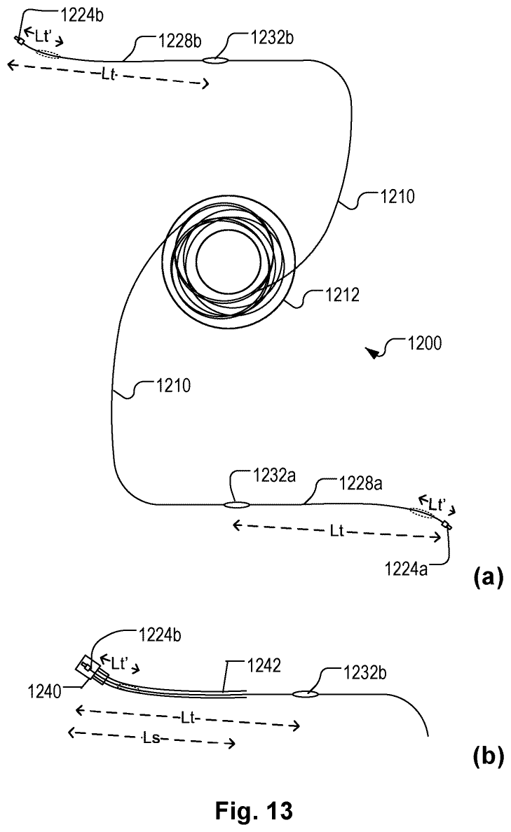

FIG. 13(a) illustrates another example of a pre-terminated optical fibre cable assembly 1200 constructed in accordance with the principles of the present disclosure. This example is a length of optical fibre cable 1210, which is pre-terminated at both ends with ferrule sub-assemblies 1224a and 1224b. The ferrule sub-assemblies are connected to the first length of cable via shorter, second and third lengths of cable 1228a, 1228b which have been pre-terminated in advance of manufacture of the cable assembly 1200. One or more optical fibres within these short lengths are connected to an optical fibre or fibres of the first length of cable by protected spliced joints 1232a and 1232b, as described above. The fibre unit 1210, as delivered, is coiled in a pan 1212, rather than being wound on a reel or drum. The types of connectors at the different ends can be the same or different. The choice of construction among the embodiments describe above may be different at the different ends. In particular, it is envisaged that one of the ends of the cable assembly 1200 might be installed by blowing, over a large distance, say, while the other end is installed over a shorter distance, for example by blowing, pushing or pulling. One of the ends may terminate at a communications cabinet, while the other end terminates within a consumer premises, such as a house or office.

As discussed above, the length Lt of the tail at either end of the cable assembly may be on the order of 1 m or a few metres (Lt in the drawing), or it may be only a few centimetres, for example in a range from 2 cm or 3 cm to 10 cm or 20 cm (Lt′). These lengths can be measured from a rearmost part of the ferrule sub-assembly, which is the spring 606 in the example of FIGS. 6 and 7. The chosen length will determine where the protected spliced joint ends up, after installation. For example, by choosing a longer tail length, it may be that the protected spliced joint remains further protected within the duct, even after the leading end of the cable has emerged from the duct. On the other hand, the protected spliced joint in such a case is not so readily accessed to make a new joint, if the original connector should become damaged, or if an additional fibre is to be brought into use. By choosing a shorter tail length, it can be arranged that the protected spliced joint is within a length of excess fibre, readily available in case a new joint should be required. Of course, the minimum length for the tail is that which allows the end of the second or third optical fibre to be prepared and subjected to the splicing operation, using the chosen equipment. As discussed above, the tail length can be different at either end of the cable assembly, just as various other parameters of the tail and the ferrule subassembly can be different.

FIG. 13(b) illustrates a variation for the second end of the fibre unit 1210, in which the second ferrule sub-assembly 1224b is housed within a ruggedised connector body 1240. The ruggedised connector body 1240 in turn is ruggedly connected to a length of protective tube 1242, which encloses some or all of the third length of cable 1228b. That is to say, the length Ls of the protective tube may be shorter than or longer than the length Lt of the “tail” formed by the third length of 1228b. In other words, the protected spliced joint 1232b may be inside protective tube 1242 (length Lt′) or outside the protective tune (Lt). The length Ls of the protective tube may be as short as a few centimetres, or it may be a few metres or longer. In this example, however, the ruggedised connector body and protective tube are pre-fitted to the second end of the cable assembly, optionally under factory conditions, rather than being added after installation. In this way, the ruggedised connector can be made under stringent conditions of cleanliness and quality control ensuring a high degree of protection for the fibre unit, where it is exposed for example in an underground chamber or telegraph pole, etc. In this case, a connector body is still added to the ferrule sub-assembly 1224a and the first end of the cable assembly, after installation through a duct.

In other embodiments, instead of a length of fibre unit enclosed a protective sheath, the third length of cable forming the ruggedised “tail” may be in itself a more substantial cable, for example a conventional drop cable.

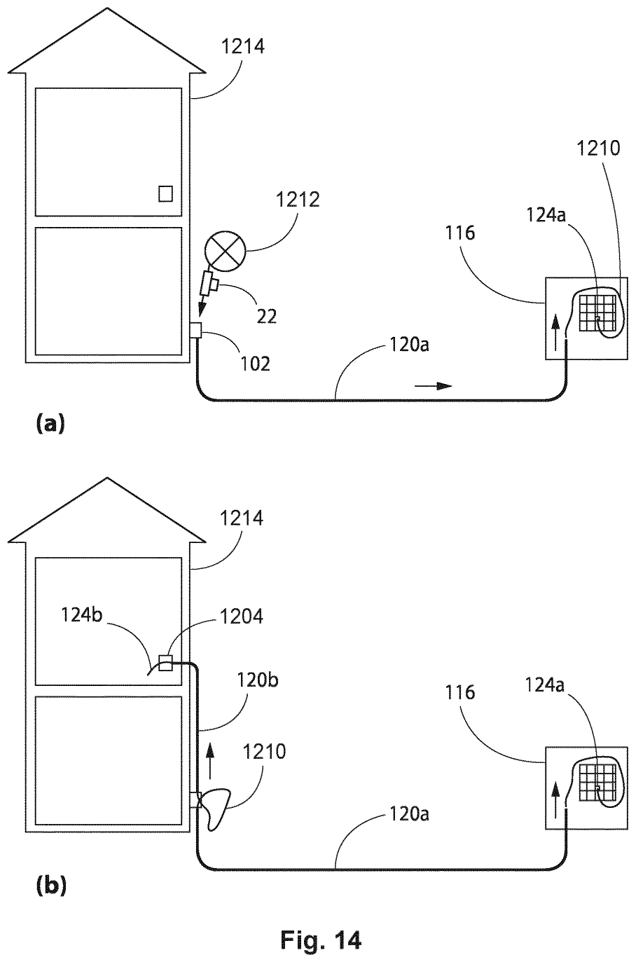

FIG. 14 illustrates an example of a method of installation, using the double-ended pre-terminated cable assembly of FIG. 13(a). Compared with the situation shown in FIG. 1, a consumer access point 1204 is on an upper storey of the building 1214. A first installation step is illustrated in FIG. 14(a) and a second installation step is illustrated in FIG. 14(b). The first installation step corresponds, for example, exactly to the blowing installation process described above with reference to FIGS. 1 and 2. From an access point 102 on the exterior of the building 1214, a first end of the cable assembly 1200 is installed by blowing to the cabinet 116 via duct 120a. This begins with inserting the leading portion of the cable including the first ferrule sub-assembly 1224a and the second length of cable 1228a into the duct, initially by pushing. The installation distance may be hundreds of metres or more. At the end of this first installation step, the second end of the cable assembly, and a coil of excess cable, remain at the access point.

In the second installation step illustrated in FIG. 14(b), the second end of the cable assembly 1200 is installed into a local drop duct 120b, to reach a particular apartment or room within the building 1214. As illustrated, this may be a consumer's connection point 1604 on an upper floor of the building. This installation step, which may comprise only a few metres of cable, may be performed by manual pushing, pulling or blowing if necessary. Within the consumer premises, the connector body can be added to the ferrule sub-assembly. Excess cable 1210 can be stored at a suitable point on the installation, for example in the home/office at connection point 1204, or in a termination housing 102 at the side of the building (as shown in FIG. 14), or at some point in between. When the cable used in cable assembly 110, 1000 or 1210 is a lightweight and compact fibre unit to begin with, storing the excess length is not a burden. In the case of a ruggedised second end as shown in FIG. 13(b), there may be no duct at all, and the ruggedised portion is simply laid into place.

### Further Example Application

FIG. 15 shows another application of the accessory and method. In the example of FIG. 15, premises 1314-1 to 1314-3 are to be connected via fibre optic cables to a cabinet 1316. The premises and cabinet may be the same as in FIG. 1 or FIG. 13, but the method of installation is different. A cabinet is used only as an example-the supply point may equally be in a manhole, telegraph pole, equipment room or the like. Each premises 1314-1 etc. has its own duct 1320-1 etc. leading to the cabinet 1316.

The steps can be substantially the same as those performed in the example above, and they do not need describing in detail. However, the location and timing of the steps is different, as will be explained.

A supply of pre-terminated tails 1152a may be manufactured at a central location in the same way as in FIG. 10. A supply of splice-protecting accessories 800a can be produced likewise. However, in this example, these components are then divided and shipped to field locations where pre-terminated cable assemblies are to be manufactured and installed. The splicing tool 910 is brought to the location of the cabinet 1316. A supply 1340 of fibre unit 1310 is received in a pan, drum or suitable container. This supply provides a source length of cable from which the first length of cable for each premises can be cut in sequence. The ducts may be for example in the region of 100 m or 200 m. The source length may be several kilometres, at the start of operations, for example more than twice the length of the duct. A second supply of tails 1152b is provided for adding to the cabinet end of each first length of cable. These may be conventional “pigtail” assemblies, well known to those skilled in the art. Splice protecting accessories 800b are provided to protect spliced joints joining the tails 1152b to the cable. These may be the same as or different to the accessories 800b, bearing in mind that they are not required to pass through the ducts.

Compared with the method of FIGS. 10 and 13, this example is different in that the first length of cable is cut from the source length of cable only after transporting the cable through the duct. As shown in FIG. 15(a), a first tail 1152a has already been spliced to a first length of cable and installed using the blowing machine 122 through duct 1320-1 to the first premises 1314-1. An accessory 800a may have passed entirely through the duct, or it may be concealed safely within the duct, as indicated by an arrow. The first ferrule sub-assembly is available to be assembled with a connector body to form a pluggable connector at the premises end (this step as illustrated in FIGS. 5 to 7, for example).

Then the fibre unit 1310 is cut between the supply 1340 and the cabinet. This can be done before or after disengaging the blowing machine from the duct. After this cutting operation, the opposite (cabinet) end of the first length of cable is accessible for splicing or otherwise connecting to a desired cable in the cabinet. In this illustrated example, this connection is achieved by splicing the first length of cable to the tail 1152b and protecting the spliced joint using the accessory 800b. The tail provides the second ferrule sub-assembly and the third optical fibre in the language of the claims.

Now referring to FIG. 15(b), we see that the tail 1152b is plugged in to a suitable adapter in the cabinet 1316. The connection between the first premises and the cabinet is complete. Additionally, for connection to the second premises 1314-2, the cut end of the source length of cable has been spliced to a new tail 1152a′ and this has been transported through the second duct 1420-2 to the second premises, repeating the steps performed for the first premises. The fibre unit is again cut at the cabinet end and a new second tail 1152b′ is spliced to it, and protected with another accessory 800b′. This provides a connector for plugging into another adapter in the cabinet, and the connection to the second premises is complete.

As will be appreciated, rather than produce multiple cable assemblies in advance, in this example we produce and install one cable assembly at a time. Then we produce a new cable assembly, using what remains of the source length of cable as a new source length of cable, and using a leading end of the new source length as the leading end of a new first length of cable. Thus, as also illustrated in FIG. 15(b), if connection to the third premises 1314-3 is required, a further tail 1152a″ and protective accessory 800a″ can be added. This process can be repeated to connect any number of further premises as desired, replenishing the supply 1340 of fibre unit 1310 as and when required.

Compared with conventional solutions, the benefit of mass-producing the tails in a factory environment are achieved, as described above. Splicing is done in the field, but no splicing required at the individual premises, since splicing is done at the cabinet for both ends of the cable assembly. No skilled engineer or equipment is required at the individual premises. No excess fibre unit is needed, because the custom length is cut from the source length after blowing.

### Further Example Cable

FIG. 16 is a schematic cross section of a further example fibre optic cable 1410 which can not only be installed by blowing, but is suitable for installation by pushing as well. This type of cable, sometimes referred to as “nanocable” is of similar construction to the fibre unit 110 of FIG. 3, but the coated fibre bundle includes at least one strength member lying alongside the optical fibres. Thus, one or more optical fibres 1406 are embedded in a solid resin material 1420 to form a coated fibre bundle, as before, but the coated fibre bundle includes a longitudinal strength member 1426, made for example of fibre reinforced plastic (FRP). The extruded sheath 1424 of PBT-based polymer surrounds the coated fibre bundle, as in the fibre unit 110. As is well known, such a strength member provides a degree of stiffness against bending, as well as strength against tensile forces. The methods and assemblies of present disclosure can be performed equally using such a cable. An outer diameter of the nanocable may be greater than that of the fibre unit without the strength member, being for example in the range of 1.2 to 2.5 mm, for example in the range 1.2 to 2.0 mm, for example 1.2 to 1.8 mm. More detail of this example is disclosed in WO2022049057A1, mentioned above with reference to FIG. 19 thereof.

It will be understood that, since the example cable 1410 of FIG. 16 has a greater diameter and stiffness than the fibre unit 110 of FIG. 3, the corresponding accessory to form a protective body around a spliced joint may be correspondingly larger in internal and/or external diameters. Since the strength member 1426 as well as the optical fibres is interrupted at the spliced joint, coupling the protective body to the sheath 1424 either side of the spliced joint are relied upon to provide protection against tensile and bending forces. This coupling may be by mechanical clamping and/or adhesive bonding, as in the previous examples. As already mentioned above, the type of cable used to fabricate the pre-terminated tail may be different from the nanocable of the main length of the cable assembly. The protective body may be asymmetrical, end to end, if required.

### Further Example Application

According to alternative methods of use (not specifically illustrated), a cable assembly can be manufactured as described above and then pre-installed in a length of duct, before the duct is installed in any premises. This pre-installed duct and cable combination can be supplied on a drum, for installation for example by burying, micro-trenching or aerial installation or any method. Once installed to the premises, a leading end section of the duct can be cut away from the cable assembly inside, to expose the second length of cable with ferrule subassembly, for making the premises connection.

### Conclusion

Using pre-terminated cable assemblies in the manner described, is known to improve the installation process, by reducing post-installation steps and time.

Additionally, following the principles of the present disclosure, the delicate steps of fibre termination and assembly of the entire pre-terminated optical fibre cable assembly with protective sleeves can be performed more efficiently in a controlled factory environment. As described, these measures can be applied to only one end of the cable assembly, or to both ends. These measures can be applied especially to a compact and lightweight cable, of the type designed for installation by blowing, although the method of installation is by no means limited to blowing. Combining these features with features of the modified fibre units described in prior patent applications WO2022049057A1 and 2111589.4, mentioned above, additional efficiencies and space savings can be obtained.

Even in embodiments where some steps of the method are performed in the field, rather than in a factory environment, the need for skilled personnel and expensive equipment can be reduced.

The present disclosure encompasses kits of parts for use in producing pre-terminated optical fibre cable assemblies of the type described, as well as the method of manufacturing such assemblies, and the stocking and distribution of such assemblies for installation, together with accessories involved in the installation. It will be appreciated that, for a commercial installation, several, perhaps tens or hundreds of individual pre-terminated cable assemblies may be provided, all of respective lengths with appropriate connector parts at one or both ends. For convenience and reliability, the connector body parts required for the completion of the connector for each pre-terminated cable assembly may be packaged together with that individual cable assembly, for example being coiled and tucked inside a cardboard or similar reel or pan (1112, 1212) on which the cable is wound.

The present disclosure encompasses methods of installation, as described, as well as methods of manufacture, the cable assemblies and kits of parts for installing the cable assemblies, and also kits of parts for making the cable assemblies.

Whilst specific embodiments of the present invention have been described above, it will be appreciated that departures from the described embodiments may still fall within the scope of the present invention.

1. A pre-terminated optical fibre cable assembly configured to be installed through a duct, the pre-terminated optical fibre cable assembly comprising:
a first length of cable comprising at least a first optical fibre embedded in a solid resin material to form a first coated fibre bundle and a first extruded polymer sheath covering the first coated fibre bundle;
a shorter, second length of length of cable comprising at least a second optical fibre and having a second extruded polymer sheath;
a ferrule sub-assembly arranged on at least a leading end of the second length of cable, the ferrule sub-assembly being adapted to become, after installation through said duct, part of a pluggable optical connector for making an optical connection to said second optical fibre; and
a spliced joint made between the first optical fibre of the first length of cable and a trailing end of the second length of cable, the spliced joint being encased in a protective body, the protective body surrounding the spliced joint and surrounding portions of said polymer sheath either side of the spliced joint and being of diameter similar to or smaller than the ferrule sub-assembly,
whereby said ferrule sub-assembly, said second length of cable, said spliced joint and protective body together form a leading portion of the cable assembly, adapted for subsequent installation through a duct.

2. An assembly as claimed in claim 1 wherein said portions of the sheath either side of the spliced joint are bonded or fused to the protective body within a bore of the protective body.

3. An assembly as claimed in claim 1 wherein said portions of the sheath either side of the spliced joint are mechanically coupled to the protective body within a bore of the protective body.

4. An assembly as claimed in claim 1 wherein the protective body is an assembly of two or more parts fixed together.

5. An assembly as claimed in claim 1 wherein said protective body comprises a generally cylindrical body having streamlined ends.

6. An assembly as claimed in claim 1 wherein said extruded polymer sheath is of a material having a tensile modulus in excess of 1500 MPa, optionally in excess of 2000 MPa, optionally in excess of 2200 MPa and optionally in excess of 2400 MPa.

7. An assembly as claimed in claim 1 wherein said extruded polymer sheath is of a material having a yield strength in excess of 30 MPa, optionally in excess of 40 MPa.

8. An assembly as claimed in claim 1: wherein at least said first extruded polymer sheath comprises a mixture of polybutylene terephthalate polymer, PBT and at least one friction reducing additive; and/or wherein the solid resin material of said coated fibre bundle is a UV-cured resin such as an acrylate material and has a tensile modulus greater than 100 MPa, optionally in the range 250-700 MPa; and/or wherein the number of optical fibres in said coated fibre bundle including any mechanical fibre is up to four and wherein an outer diameter of said cable is less than 1.2 mm, optionally less than 1.1 mm, or wherein the number of optical fibres including any mechanical fibre is up to 6, 8, 12 or 24 fibres and an outer diameter of the cable is less than 1.3, 1.5. 1.6 and 2.1 mm, respectively; and/or wherein an outer diameter of the protective body is less than 3.0 times, optionally less than 2.5 times, optionally less than 2.2 times the diameter of the cable, or is less than 3.5 mm, optionally less than 3.0 mm, optionally less than 2.8 mm; and/or wherein an overall length of said protective body is less than 40 mm, optionally less than 30 mm, optionally less than 25 mm; and/or wherein the first length of cable has a length greater than 10 m, optionally greater than 20 m, and the second length of cable has a length less than 10 m, optionally less than 3 m, optionally greater than 1 m, optionally less than 0.5 m, optionally less than 0.2 m, optionally less than 0.1 m, measured from a rearmost part of the ferrule sub-assembly; and/or wherein the cable is packaged as a winding on a reel with said leading end being at the outer turns of said winding; and/or wherein an end of the first length of cable opposite to the leading end is also provided prior to installation in a duct with a second ferrule sub-assembly, and, optionally, wherein said second ferrule sub-assembly is incorporated prior to installation into a ruggedised connector assembly.

9. (canceled)

10. (canceled)

11. (canceled)

12. (canceled)

13. (canceled)

14. (canceled)

15. (canceled)

16. (canceled)

17. (canceled)

18. (canceled)

19. A method of assembling a pre-terminated optical fibre cable assembly configured to be installed through a duct, the method which is performed prior to installation in said duct comprising the steps:
(a) providing a first length of cable comprising at least a first optical fibre embedded in a solid resin material to form a first coated fibre bundle and a first extruded polymer sheath covering the first coated fibre bundle;
(b) providing a shorter, second length of cable comprising at least a second optical fibre and having a second extruded polymer sheath, said second length of cable having a leading end and a trailing end, and having a ferrule sub-assembly already fixed on its leading end, the optical ferrule being adapted to become, after installation through said duct, part of a pluggable optical connector for making an optical connection to the second optical fibre;
(c) forming a spliced joint between said first optical fibre at a leading end of the first length of cable and the second optical fibre at the trailing end of the second length of cable; and
(d) encasing the spliced joint in a protective body, the protective body being of diameter similar to or smaller than the ferrule sub-assembly and surrounding the spliced joint and surrounding portions of said first and second polymer sheaths either side of the spliced joint.

20. A method as claimed in claim 19 wherein in step (c) said portions of the sheath either side of the spliced joint are bonded or fused to the protective body within a bore of the protective body.

21. A method as claimed in claim 19: wherein said portions of the sheath either side of the spliced joint are mechanically coupled to the protective body within a bore of the protective body; and/or wherein the protective body is received in two or more parts and fixed around the spliced joint to form a single body; and/or wherein said protective body is provided with at least one port, and wherein a bonding agent, filling agent and/or sealant is injected as a liquid through said port into a bore of the protective body; and/or wherein the second length of cable provided in step (a) is received in a batch with a number of similar lengths of cable, which have all been provided with respective ferrule sub-assemblies prior to performance of the method.

22. (canceled)

23. (canceled)

24. (canceled)

25. (canceled)

26. (canceled)

27. (canceled)

28. (canceled)

29. (canceled)

30. An accessory for encasing a spliced joint between optical fibres, the accessory comprising one or more parts that are adapted to be fixed around the spliced joint to form a generally cylindrical protective body with streamlined ends, the protective body optionally having an outer diameter less than 3.5 mm, optionally less than 3.0 mm, optionally less than 2.8 mm, and optionally having a length less than 40 mm, optionally less than 30 mm, optionally less than 25 mm, the protective body having an inner bore, the inner bore including a central portion for accommodating a spliced joint between first and second optical fibres, the inner bore further including first and second outer portions for surrounding portions of first and second polymer sheaths either side of the spliced joint, the inner bore optionally having a diameter at least in said outer portions that exceeds 0.6 mm, optionally exceeds 0.7 mm, optionally exceeds 0.8 mm, and optionally exceeds 0.9 mm.

31. An accessory as claimed in claim 30; wherein said outer portions of the inner bore have a diameter greater than said central portion; and/or wherein the accessory comprises two or more parts that are brought together to form the protective body.

32. (canceled)

33. (canceled)

34. (canceled)

35. A method of installing a pre-terminated optical fibre cable assembly according to claim 1, the method comprising the steps:
inserting the leading portion of said cable including said ferrule sub-assembly and said second length of cable into a duct; and
transporting a further length of the cable including at least a portion of the first length of cable through the duct until the leading portion of the cable protrudes from the duct; and
adding a connector body to the ferrule sub-assembly to complete said pluggable optical connector.

36. A method as claimed in claim 35 wherein said pluggable optical connector is designed to pull out of a compatible adapter or socket with a force less than 30 N, optionally less than 25 N.

37. A method as claimed in claim 35; wherein the transporting step is performed by blowing over a distance greater than 50 m, optionally greater than 100 m; or wherein the transporting step is performed by pushing over a distance greater than 25 m, optionally greater than 50 m.

38. (canceled)

39. A method as claimed in claim 35, further comprising using said pluggable optical connector to connect the at least one optical fibre to supply equipment or to consumer equipment.

40. A method as claimed in claim 35 wherein said first length of cable is received as part of a source length of cable more than twice the length of the duct, and wherein the method further comprises:
cutting the first length of cable from the source length of cable after the transporting step.

41. A method as claimed in claim 35 further comprising:
after the transporting step, providing an end of the first length of cable opposite to the leading end with a second ferrule sub-assembly, and, optionally, wherein providing the second ferrule sub-assembly comprises:
providing the second ferrule sub-assembly already connected to a first end of a third optical fibre within a third length of cable shorter than the first length of cable, connecting a second end of the third optical fibre to the first optical fibre by a second splice joint, and
protecting the second spliced joint by surrounding the second spliced joint with a second protective body, and, further optionally, wherein said second ferrule sub-assembly is preassembled with a connector body prior to connecting the third optical fibre to the first optical fibre.

42. (canceled)

43. (canceled)

44. (canceled)

45. A kit of parts for installing an optical fibre cable, the kit of parts comprising:
a pre-terminated optical fibre cable assembly according claim 1; and
a connector body for adding to the ferrule sub-assembly to complete said pluggable optical connector.

46. (canceled)
